(19) United States
(12) Patent Application Publication
(10) Pub. No.: US 2020/0314648 A1
(43) Pub. Date: Oct. 1, 2020

(54) Distributed HSS Using Blockchain

(71) Applicant: Parallel Wireless, Inc., Nashua, NH (US)

(72) Inventor: Yang Cao, Westford, MA (US)

(21) Appl. No.: 16/834,573

(22) Filed: Mar. 30, 2020

Related U.S. Application Data
(60) Provisional application No. 62/826,563, filed on Mar. 29, 2019.

(51) Int. Cl. H04W 12/06; H04L 29/06; H04L 9/06; G06F 16/23

(52) U.S. Cl. CPC H04W 12/06; H04L 63/0876; H04L 2209/38; G06F 16/2379; H04L 9/0637; H04L 9/0643

(57) ABSTRACT

A method of authenticating Internet of Things (IOT) devices is presented. The method includes determining a need for an IoT device authentication. The method also includes identifying at least one random edge node to perform the authentication, and authenticating the IoT device by the at least one edge node. The method further includes adding an authentication record regarding the authentication of the IoT device to a block and accumulating a plurality of authentication records in the block. The method additionally includes adding the block to a blockchain.

### CROSS-REFERENCE TO RELATED APPLICATIONS

This application claims priority under 35 U.S.C. § 119(e) to U.S. Provisional Pat. App. No. 62/826,563, filed Mar. 29, 2019, titled “Distributed HSS Using Blockchain” which is hereby incorporated by reference in its entirety for all purposes. This application also hereby incorporates by reference, for all purposes, each of the following publications in their entirety for all purposes: U.S. Pat. App. Pub. Nos. US20140133456A1, US20150094114A1, US20150098385A1, US20150098387A1, US20160044531A1, US20170013513A1, US20170019375A1, US20170026845A1, US20170048710A1, US20170055186A1, US20170064621A1, US20170070436A1, US20170077979A1, US20170111482A1, US20170127409A1, US20170171828A1, US20170181119A1, US20170202006A1, US20170208560A1, US20170238278A1, US20170257133A1, US20170272330A1, US20170273134A1, US20170288813A1, US20170295510A1, US20170303163A1, US20170347307A1, US20180123950A1, and US20180152865A1; and U.S. Pat. Nos. 8,867,418, 8,879,416, 9,107,092, 9,113,352, 9,232,547, and 9,455,959.

### BACKGROUND

Blockchain has become increasingly popular. A blockchain is a growing list of records, called blocks, which are linked using cryptography. Each block contains a cryptographic hash of the previous block, a timestamp, and transaction data. By design, a blockchain is resistant to modification of the data. It is an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority.

In recent years, with the proliferation and reduction in price of telecommunications chips, devices that have previously not been able to connect to other devices and the Internet have been enabled to do so. The Internet of Things (IoT) is a network of heretofore unconnected devices, such as vehicles and home appliances, that contain electronics, software, actuators, and connectivity that allows these devices to connect, interact and exchange data, and that enables these devices to be remotely monitored and controlled. The 5G standard has as one of its design goals the provision of connectivity to IoT devices. The term IoT is used herein to also refer to the devices as well as to the network.

### SUMMARY OF THE INVENTION

The presently disclosed method, apparatus and software for distributed Home Subscriber Server (HSS) using blockchain relates generally to using a blockchain for providing decentralized authorization to computing devices on a mobile network. In an exemplary embodiment a method of verifying Internet of Things (IOT) devices includes determining a need for an IoT device authentication. The method further includes identifying at least one random edge node to perform the authentication, and verifying the IoT device by the at least one edge node. The method additionally includes adding an authentication record regarding the verification of the IoT device to a block. The method also includes accumulating a plurality of authentication records in the block, and adding the block to a blockchain.

In another embodiment, a system for authenticating Internet of Things (IOT, includes a HetNet Gateway (HNG); at least one base station in wireless communication with the HNG, the at least one base station includes at least one random edge node; and an IoT device in wireless communication with a base station; wherein the HNG determines a need for an IoT device authentication; identifies at least one random edge node to perform the authentication; the at least one random edge node authenticates the IoT device; an authentication record regarding the authentication of the IoT device is added to a block; a plurality of authentication records are accumulated in the block; and the block is added to a blockchain.

In another embodiment, a non-transitory computer-readable medium contains instructions for authenticating Internet of Things (IOT) devices which, when executed, cause a system to perform steps including determining a need for an IoT device authentication; identifying at least one random edge node to perform the authentication; authenticating the IoT device by the at least one random edge node; adding an authentication record regarding the authentication of the IoT device to a block; accumulating a plurality of authentication records in the block; and adding the block to a blockchain.

Other aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 is a block diagram of an example blockchain.

FIG. 2 is a block diagram of an example IoT device.

FIG. 3 is an example diagram of a telecommunications network including edge devices in accordance with some embodiments.

FIG. 4 is a schematic network architecture diagram for various radio access technology core networks.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

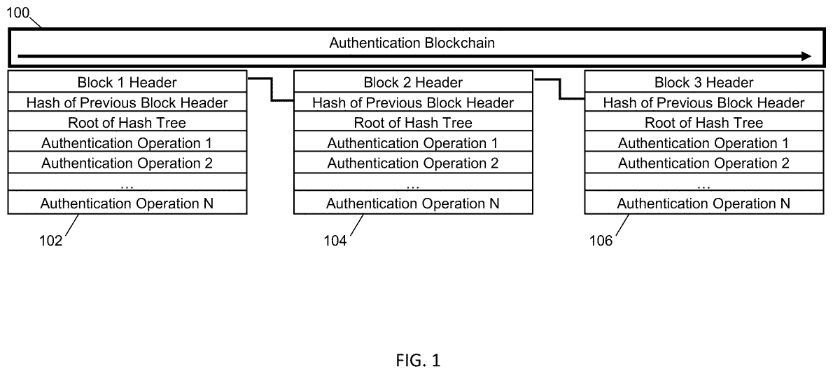

The use of a blockchain has become popular. An example blockchain 100 is shown in FIG. 1. In this example, the blockchain 100 comprises a content or data structure having a number of serially ordered, back-linked blocks 102, 104, 106 of validated electronic information that may be widely copied to, read from, or written to. A block is typically a container-type content or data structure that aggregates a list of electronic information and references back to a previous block in the chain (sometimes referred to as a parent block) via a hash of the previous block in the chain. As such, in a blockchain, each block contains a hash of its parent block, linking blocks in the chain via a sequence of hashes all the way to the very first block. Because a current block's hash incorporates a previous block's hash in a blockchain, changing or modifying a parent block would modify a hash of its child's block. In turn, changing or modifying a child block would modify a hash of a grandchild's block and so on. This type of arrangement ensures that a prior block in a chain is extremely difficult to modify due in part, to the compute intensive and time-consuming effort involving re-computations of all previous blocks. Accordingly, prior blocks in a chain become accepted history, and are therefore more secure.

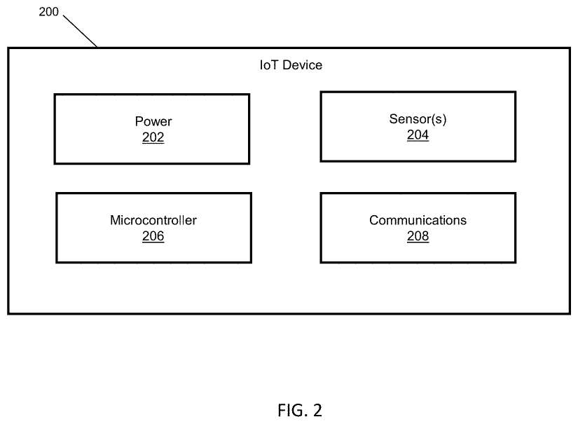

The Internet of Things (IoT) is generally a system of interconnected and/or internetworked physical devices in which computing is embedded into hardware so as to facilitate and/or support devices' ability to acquire, collect, and/or transfer content or data over one or more communications networks. An example IoT device 200 is shown in FIG. 2. The IoT device 200 includes a power source 202, one or more sensors 204, a microcontroller 206 and a communications element 208. IoT devices include a wide variety of embedded devices including but not limited to sensors, transponders, implants, kitchen appliances, locks, or the like having an assigned Internet Protocol (IP) address and having the ability to transfer content or data over one or more communications networks.

Currently, in the telecom network, various network devices and user devices (user equipments, or UEs, in LTE and otherwise named in other telecom standards) attempt to authenticate to the network by causing the network to contact a server, called the Home Subscriber Server (HSS). The HSS is the master user database in the network that lists user profiles and provides authentication and authorization of the user. In 2G, this server was called the Home Location Register (HLR); in LTE, this server also incorporates functions of the prior-known Authentication Center (AuC). This server also is sometimes responsible for providing information about the last known physical location of the user. When a device turns on and requests access to the network, the device submits a credential based on a pre-shared key K stored in the hardware (typically on the SIM card). A copy of this key is stored at the HSS. By comparing a computation based on the key sent by the UE at the MME with a computation based on a derived version of the key generated at the HSS and sent to the MME, the network is able to authenticate the device for initial network access. The derived key (K_{ASME}) is sent to the MME but the underlying key K is never sent to the MME. Further security keys (for example, for NAS and AS security) are derived from K_{ASME}.

The above method is simple in that it is generally centralized on the HSS, but this centralization is a problem when viewed in the light of the IoT deployment scenario. For example, in order to handle the authentication load of thousands or millions of devices coming online after a power outage, the HSS will need to be significantly overprovisioned, and must be enabled to distinguish between legitimate requests and denial of service attacks. Another problem is that it is expensive to compute the derived keys at the user device itself.

By using blockchain, a distributed HSS may be enabled that is able to do reliable access control, has offload capability throughout the network, but still retains centralized traceability within the network. While the present description recites the use of a blockchain, it should be appreciated that anywhere a blockchain is referred to herein, a standard database could also be used in place of a blockchain.

In some embodiments, a blockchain checker may be present at the eNodeB/base station, MME, or other network node in the network. Whenever a new IoT device is deployed, blockchain is used to add new blocks to the chain to authenticate that device. A single chain is used to authenticate all devices throughout the network, but parts of the chain may be delegated or distributed to various portions of the network, e.g., the eNB or MME, with the synchronization of the chain being affected by the blockchain protocol. Any attach of a device is mutable (changeable), and is easy to track and identify, since the blockchain is available to everyone at any time.

A blockchain protocol may be selected that is not extremely computationally expensive. Information already embedded in the SIM (or eSIM) may be used in part to generate unique IDs for facilitating block construction. This invention is not limited to use by IoT devices and could be used to provide decentralized HSS for any mobile network and any mobile device.

Edge computing is computing that is done at or near the source of the data, instead of relying on the cloud to do all the work. There is a general trend towards edge computing in 5G, due to latency and backhaul concerns. The fully distributed structure of blockchain enables edge computing. Today, the access/authorization structure goes to the HSS. Both human devices and autonomous/dumb devices go to the same place. But the potential volume for IoT devices is much bigger. Another issue is addressing centralization of current authorization method.

The small number of Home Subscriber Service (HSS) make it easy to target an effective attack if you are doing a Distributed Denial of Service (DDOS) attack. To counter this, we propose leveraging compute at the edge to put the HSS functionality, specifically, verification of UE credentials, at a distributed edge node. Heavy compute enables scalability, especially given the linear increase of compute resources with the IOT devices, while making a DDOS attack more difficult. The verification of the IoT node is distributed to random edge devices. A node that is authenticated can add to the chain. Each verification is a record in a chain, and each block can have a list of transactions.

Operation of the network can be deterministic even though verification is distributed. You do not have to guess which node to verify your credentials with, as follows. Blockchain includes a notion called proof of work. Proof of work can be as follows: determination of a random number using a known hash function. Everyone competes to figure out what the number should be such that the hash output has some pattern or property, and the first node to “win” is assigned to verify your credentials. The proof of work is fully distributed, therefore any potential malicious attack can be avoided.

As with other blockchain technologies, whoever participates as a node in performing verification adds a new block to the chain. There is more randomness added for the authentication so that you are not able to control which node performs the authentication of your device, making it hard to do an attack. This provides multiple benefits, one benefit is that this provides more randomness—for security and DDOS avoidance. Another benefit is that a malicious node cannot fake its own credentials.

Selection of the authenticating node will also use the information about which virtual HSS to query. For example, roaming will cause an appropriate virtual HSS to query that is, for example, closer to the home network or closer to the visited network depending on requirements. If an authentication is performed in another network, then, a two-way authentication process is performed.

IOT can include multiple processing. These may include a public key, two sided multiple authentication and a random number signed signature. These computations are pushed to a random edge node. From the IOT device's perspective, there is no difference.

There may be one or more databases involved with this. One database is an inventory database. With each SIM, when you get from the carrier, has information stored in it that is stored at the carrier as well. This information is pushed to a decentralized database that would be owned by all devices. In some embodiments, each node could have a fraction of it (might be too large, burdensome to maintain). The arbitration process at the node makes this work using hash entries, which are fully distributed to each node. Like Redundant array of Inexpensive Disks (RAID), it can be distributed in such a way that multiple nodes must fail to cause the distributed database to lose data. This helps provide resiliency.

Another aspect has to do with verification data. Blocks are eventually added to the chain. The data in the blocks is immutable once saved to the chain. This is even more secure than the current method, which is an HSS and vulnerable to internal malicious activity. The chain can synchronize in a slow manner.

When someone would like to authorize an IOT device, there is a random selection process to identify which edge node will used to authorize the device. This adds randomness to the process. A two-way authentication will be conducted, as if it were an HSS. The authentication records will be accumulated into a block, and when the block is complete, added to the chain. This process may further include a “proof of credibility”.

Another aspect is using this type of process to place control plane messages into an immutable blockchain as well. This makes the record of messages non-hackable and a secure process. This could include, e.g., X2, S1, 4G, 5G. This could take place among and between vendors. This may involve containers, VMs, VNF. Since this is distributed, computes can be moved around too and increase available resources. If it is known there is going to be a power failure, more containers can be provisioned. An arbiter could be realized as an HNG. The HNG could handle arbitration for the CWSs that it manages. The HNG could be a selection node as well. In the event of a cache miss, the HSS is used as a fallback.

One of the key security threats for the current IoT deployment is the potential Distributed Denial of Service (DDOS), because given today's central HSS architecture, it's very easy for the hackers to figure out and program the IoT device to attack the targeted HSS.

In the blockchain architecture as used in the presently described method and apparatus, some key central function like HSS and PCRF may be distributed. PCEF may be distributed and the execution of certain policy may be triggered via smart contract. When authenticating to the network, an IoT device can be authenticated by selecting a randomized miner, which will perform distributed HSS and PCRF function, and complete the transaction, generate the block (consisting of multiple transactions) and add to a blockchain. A single blockchain is shared across all miners. The immutability of the blockchain is still based on including in the current block the hash value of the previous block.

In one example, there are N miners (N is a pre-determined number). Like any other devices, the IoT device will also get its TMSI (Temporary Mobile Subscriber Id) after attaching procedure. The random miner selection can be completed via the following formula:

Hash(TMSI) mod N

Here Hash function is pre-determined. It can be MD-5, SHA-1, SHA-2, SHA-3 or others. Using TMSI instead of IMSI adds additional randomness to this selection.

In this way, hackers will have no way figuring out the central function location in advance, hence providing a secured scheme against attacks like DDoS. Meanwhile the fact that N miners share the distributed load of HSS and PCRF also significantly facilitate the secured exponential growth of IoT deployment.

In some embodiments, an element management system (EMS) or EMS gateway may be equipped with the blockchain checker to enable the EMS system to trace the location and authorization of devices on the network that have been authenticated.

In some embodiments, blockchain may be used for basic device authentication (mutual authentication between the UE and the network); non-access stratum (NAS) security and authentication of signaling; and access stratum (AS) security and ciphering of RRC signaling and user traffic between the UE and the base station, as well as any combination or subcombination thereof. In some embodiments, blockchain may be used to authenticate eNodeBs to the network. In some embodiments, blockchain may be used to authenticate the network to eNodeBs, or core network nodes to edge nodes.

In some embodiments the HNG(s) select a subset of eNBs (based on remaining processing power) as the candidate pool. All eNBs vote based on connection/load/transactional-success performance to decide within this pool, which subset will join as part of N miners. (The vote process would take place periodically, period/frequency is defined by the HNG). Via hash(TMSI) mod N, the IOT device will identify which miner to serve. The attached eNB will direct the UE<->HHS traffic to the identified miner-N.

The HNG assigns the private key and public key pair to each eNB. Traffic directly by the eNB to the miner is digitally signed via each eNB's private key assigned by the HNG. The miner will verify the received message via this eNB's public key assigned by the HNG. In this way, protection against compromised eNBs is achieved. Also, in this way, IoT device can perform as is according to the current 3GPP standard. The blockchain logic as described here can be implemented purely on the eNB/6 side.

The original DB will be distributed for reliability among N miners. Each miner can generate/add the block which consists of groups of IOT transactions.

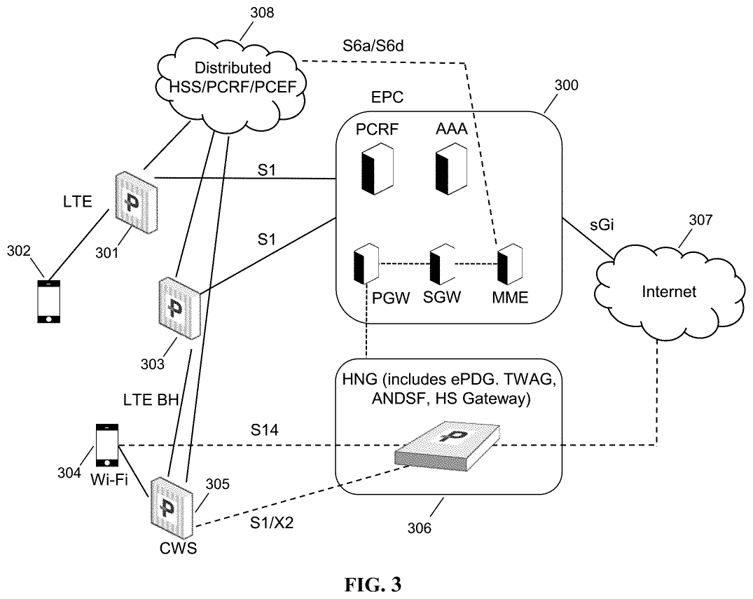

FIG. 3 is a schematic diagram of a wireless network architecture, in accordance with some embodiments. A conventional mobile network is shown, including Long Term Evolution (LTE) macro eNodeBs 301 and 303, LTE UE 302, evolved packet core (EPC) 300, and Internet 307. EPC 300 includes a policy, charging and rules function (PCRF), an authorization, authentication and accounting (AAA) node, a packet data network gateway node (PGW), a serving data network gateway node (SGW), and a mobility management entity (MME). In addition, a Wi-Fi UE 304 is shown, which connects to Wi-Fi access point 305 for Wi-Fi access, and which connects via an S14 interface to an ePDG 306. Wi-Fi AP 305 is labeled “CWS” and can be an enhanced eNodeB/Wi-Fi multi-RAT node, in some embodiments, such as the Parallel Wireless Converged Wireless System (CWS) [TM]. ePDG 306 includes additional elements, such as a trusted wireless access gateway (TWAG), ANDSF, HS Gateway, etc. and is labeled “HNG”; this node can be a Parallel Wireless HetNet Gateway [TM], in some embodiments. The HNG sits between a wireless radio access network (RAN) and its core network. For more details about the HNG the reader is referred to U.S. Pat. Pub. No. 20150257051, hereby incorporated by reference for all purposes.

The Wi-Fi UE 304 is attached to the CWS 305, which is coupled through LTE backhaul to core network 303, 300, and via core network 300 and Internet 307 to HNG 306. HNG 306 provides coordination of CWS 305 via a point-to-point connection; specifically, an IPsec tunnel is formed between 305 and 306 to permit transfer of signaling and data. This tunnel prevents EPC 300 from being able to read or alter the data, even as the data moves through the core network. For more details about the LTE backhaul connection the reader is referred to U.S. patent application Ser. No. 35/202,496, issued as U.S. Pat. No. 9,386,480, hereby incorporated by reference in its entirety. It is noted that CWS 305 includes a physical UE card coupled electrically to the CWS as a module, with its own subscriber identity module (SIM) card, used to connect to macro base station 303.

The EPC 300 no longer includes a home subscriber server (HSS). Instead, the HSS is now part of a distributed HSS 308. The distributed HSS communicates with the MME in standard fashion by way of S6a/S6d messaging, and performs functions to authenticate subscribers, provide services to subscriber, and to store location information of subscriber sent by MME. For example, the S6 messages that can be exchanged between MME/SGSN and HSS and the MME can include:

AIR/AIA (Authentication-Information-Request/Answer):—MME fetches Authentication data from HSS to authenticate subscriber.

ULR/ULA (Update-Location-Request/Answer):—MME stores its own identity at HSS, and fetches subscription data from HSS.

NOR/NOA (Notification-Request/Answer):—MME stores PDN address and other attach information at HSS.

PUR/PUA (Purge Request/Answer):—MME informs the HSS that UE is inactive for a long period, and that is why MME has deleted the Subscription Data received in previous ULR from its end.

IDR/ADA(Insert-Subscription-Data-Request/Answer):—It is invoked by HSS only when a subscriber is attached and there is change in subscriber profile at HSS end then same change to be reflected at Subscriber profile at MME (sent in ULA) end as well.

DSR/DSA (Delete-Subscriber-Data-Request/Answer):—This is invoked by HSS only when Subscriber is attached and some data is deleted at HSS. Now HSS informs MME with this message that some part of subscription data is deleted at HSS.

CLR/CLA(Cancel-Location-Request/Answer):—This is invoked by HSS to detach the subscriber.

RSR/RSA(Reset-Request/Answer):—This is invoked by HSS, to inform MME that HSS goes down for some time, kindly sync the data and send fresh location/PDN information at HSS.

The distributed HSS 308 is implemented using CPU resources at base stations 301, 303, 305 operating together, which are miner nodes. The miner nodes authenticate each other using proof of credibility to ensure the data is not corrupted by a rogue node. Each miner node provides authentication for its own attached mobile devices, in some embodiments, for example, with UE 302 being authenticated via distributed HSS 308 using resources at node 301. In other embodiments, or in some cases in concert, the authenticating node may be determined based on a hash function of the mobile device identifier, as discussed above. Voting may be performed to include a subset of nodes as the distributed HSS. Data can be stored across all of the nodes in a blockchain, with each node filling up one block at a time until the block is full and then writing the block to the chain throughout the network. Periodically, data can be written in a one-way fashion from the distributed HSS to a database that is used for storage only (and not for providing authentication services as an HSS), enabling billing and other HSS backend services. In some embodiments, the distributed HSS service can be provided to only a subset of devices, for example IoT devices.

In addition to the HSS, many other core functions like PCRF and PCEF can also be equally distributed to the edge (miners), in a similar fashion as with the HSS above, and using resources of eNodeBs or other nodes in the network. The policy charging and rules function (PCRF) and policy charging and enforcement function (PCEF) also require a secure server that is not vulnerable to attack and also is defensible against rogue data insertions; therefore the same or similar mechanisms described above could be used, for example, distributing policy rule storage across multiple nodes; using miners to validate rule edits and writes; using voting to assign a single node to provide policy rule retrieval and policy rule enforcement; authenticating the distributed PCRF/PCEF nodes with each other and with the base stations in the network; etc. In some embodiments, smart contracts can be stored and invoked based on messaging from eNBs/HNG to trigger the PCEF to take the autonomous traffic-policing and QoS related or legal intercept etc. functions. The inventors have also contemplated the use of this technique for 5G standalone as well as 5G nonstandalone core architectures, and the control and user plane separation (CUPS) of 5G enables greater flexibility when provisioning distributed core network nodes in the control plane.

Some example methods, apparatuses, and/or articles of manufacture are disclosed herein that may be used, in whole or in part, to facilitate and/or support one or more operations and/or techniques for using a blockchain in connection with one or more IoT devices.

The above methods and systems could be used generally to provide authentication for any network that uses a key to authenticate, but in particular is contemplated to be for cellular access networks, e.g., 2G, 3G, 4G, 5G, etc. and any network using any centralized coordination functionality to facilitate authentication, call or data routing, mobility management, etc. for mobile devices.

The above methods and systems do not require the systems to be placed at the edge, as the above disclosure could be used to provide distributed services within a telecommunications core network as well as at the edge of such a network. For example, an HSS functionality could be provided distributed across multiple core network HSS servers serving different geographies, with the distribution being performed across multiple servers according to what is disclosed herein.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

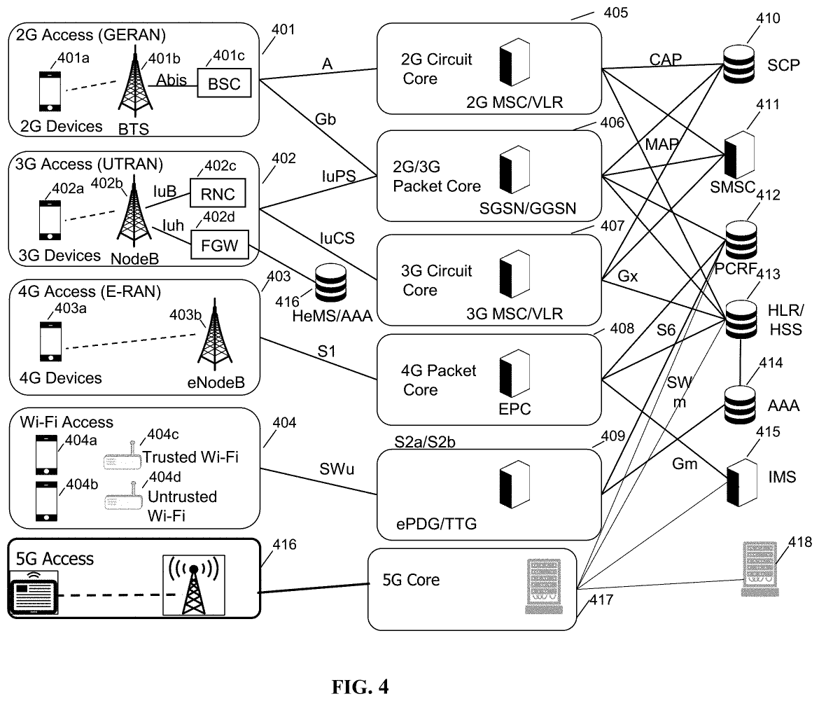

FIG. 4 is a schematic network architecture diagram for 3G and other-G prior art networks. The diagram shows a plurality of “Gs,” including 2G, 3G, 4G, 5G and Wi-Fi. 2G is represented by GERAN 401, which includes a 2G device 401a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

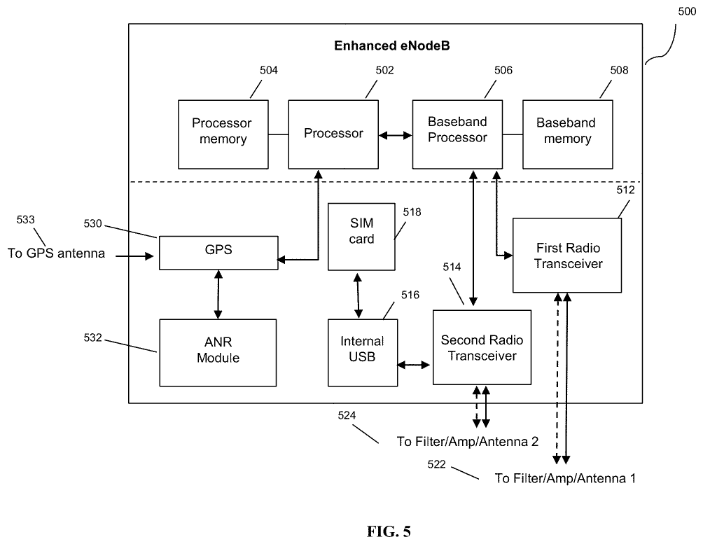

FIG. 5 is an enhanced eNodeB for performing the methods described herein, in accordance with some embodiments. Mesh network node 500 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500.

Processor 502 and baseband processor 506 are in communication with one another. Processor 502 may perform routing functions, and may determine if/when a switch in network configuration is needed. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

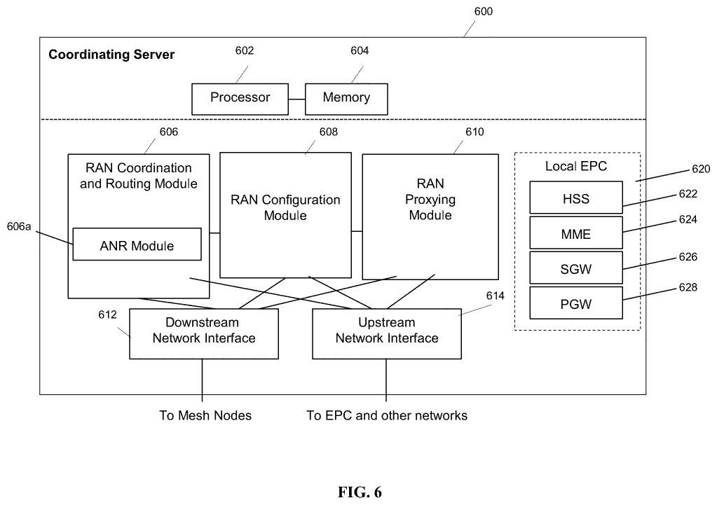

FIG. 6 is a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, legacy TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

The foregoing discussion discloses and describes merely exemplary embodiments of the present invention. As will be understood by those skilled in the art, the present invention may be embodied in other specific forms without departing from the spirit or essential characteristics thereof. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology.

What is claimed is:

1. A method of authenticating Internet of Things (IOT) devices, comprising:
determining a need for an IoT device authentication;
identifying at least one random edge node to perform the authentication;
authenticating the IoT device by the at least one random edge node;
adding an authentication record regarding the authentication of the IoT device to a block;
accumulating a plurality of authentication records in the block; and
adding the block to a blockchain.

2. The method of claim 1 wherein adding the block to a blockchain includes adding the block to a blockchain comprising a data structure having a number of serially ordered, back-linked blocks of validated authentication information.

3. The method of claim 1 wherein a verifying of credentials is performed at a distributed edge node.

4. The method of claim 1 further comprising utilizing proof of work to verify credentials.

5. The method of claim 4 wherein utilizing proof of work includes determining a random number using a known hash function, and wherein nodes compete to determine what the random number should be such that the hash output has some pattern or property, and the first node to determine the random number is assigned to verify credentials.

6. The method of claim 1 wherein authenticating the IOT includes selecting a randomized miner, the randomized miner performing distributed Home Subscriber Server (HSS) using and policy, charging and rules function (PCRF), completing the transaction, generating the block, and adding the block to the blockchain.

7. The method of claim 1 further comprising adding control plane messages to the blockchain.

8. The method of claim 1 further comprising processing at least one of a public key, two sided multiple authentication, and a random number signed signature.

9. A non-transitory computer-readable medium containing instructions for authenticating Internet of Things (IOT) devices which, when executed, cause a system to perform steps comprising:
determining a need for an IoT device authentication;
identifying at least one random edge node to perform the authentication;
authenticating the IoT device by the at least one random edge node;
adding an authentication record regarding the authentication of the IoT device to a block;
accumulating a plurality of authentication records in the block; and
adding the block to a blockchain.

10. The computer-readable medium of claim 9 further containing instructions wherein a verifying of credentials is performed at a distributed edge node.

11. The computer-readable medium of claim 9 further containing instructions utilizing proof of work to verify credentials.

12. The computer-readable medium of claim 11 further containing instructions wherein utilizing proof of work includes determining a random number using a known hash function, and wherein nodes compete to determine what the random number should be such that the hash output has some pattern or property, and the first node to determine the random number is assigned to verify credentials.

13. The computer-readable medium of claim 9 further containing instructions wherein authenticating the IOT includes selecting a randomized miner, the randomized miner performing distributed Home Subscriber Server (HSS) using and policy, charging and rules function (PCRF), completing the transaction, generating the block, and adding the block to the blockchain.

14. The computer-readable medium of claim 9 further containing instructions adding control plane messages to the blockchain.

15. A system for authenticating Internet of Things (IOT, comprising:
a HetNet Gateway (HNG);
at least one base station in wireless communication with the HNG, the at least one base station includes at least one random edge node; and
an IoT device in wireless communication with a base station;
wherein the HNG determines a need for an IoT device authentication;
identifies at least one random edge node to perform the authentication;
the at least one random edge node authenticates the IoT device;
an authentication record regarding the authentication of the IoT device is added to a block;
a plurality of authentication records are accumulated in the block; and
the block is added to a blockchain.

16. The system of claim 15 wherein a verifying of credentials is performed at a distributed edge node.

17. The system of claim 1 further comprising utilizing proof of work to verify credentials.

18. The system of claim 17 wherein utilizing proof of work includes determining a random number using a known hash function, and wherein nodes compete to determine what the random number should be such that the hash output has some pattern or property, and the first node to determine the random number is assigned to verify credentials.

19. The system of claim 15 wherein authentication by the IOT includes selecting a randomized miner, the randomized miner performing distributed Home Subscriber Server (HSS) using and policy, charging and rules function (PCRF), completing the transaction, generating the block, and adding the block to the blockchain.

20. The system of claim 15 wherein control plane messages are added to the blockchain.
